(19) United States
(12) Patent Application Publication
(10) Pub. No.: US 2019/0104805 A1
(43) Pub. Date: Apr. 11, 2019

(54) SHOE SOLE

(71) Applicant: ARKISTAR SRL, San Miniato (PI) (IT)

(72) Inventors: Alberto DEL BIONDI, Padova (IT); Alessio RIZZI, Caselle di Santa Maria di Sala (VE) (IT)

(73) Assignee: ARKISTAR SRL, San Miniato (PI) (IT)

(21) Appl. No.: 16/085,045

(22) PCT Filed: Aug. 1, 2016
(86) PCT No.: PCT/IB2016/054610

§ 371 Date: Sep. 14, 2018

(30) Foreign Application Priority Data
Mar. 16, 2016 (IT) 102016000027822
Aug. 1, 2016 (IT) 102016000080668

(51) Int. Cl. A43B 13/12; A43B 13/18; B32B 7/12; B32B 3/26; B32B 37/12

(52) U.S. Cl. CPC A43B 13/125; A43B 13/181; A43B 13/183; A43B 13/185; A43B 3/128; B32B 3/266; B32B 3/263; B32B 37/12; B32B 7/12

(57) ABSTRACT

Shoe sole (100) comprising a main structure (10) that defines a tread surface (1) and opposing sides (11, 12) of the sole, said main structure (10) comprising a top layer (16) facing, in use, the sole of the foot, a bottom layer (15) facing the ground, and a reinforcing member (5) interposed between said top (16) and bottom layers (15). The reinforcing member (5) is made of a material with greater rigidity than the bottom layer (15), and comprises a front portion (52) and a rear portion (54) joined together by a bridging section (53). A forefoot through opening (20) is defined on the front portion and a hindfoot through opening (40) is defined on the rear portion, in such a way that a midfoot through opening (30) is defined between the bridging section (53) and the bottom layer (15).

The invention relates to a shoe sole of the type having the characteristics mentioned in the preamble to the main claim.

It is known to use shoe soles that have a series of openings that develop over the entire width in order to increase the flexibility characteristics in specific areas of the sole.

For example, patent U.S. Pat. No. 8,291,615 describes a sports shoe that comprises a sole formed by two opposing surfaces joined at a series of protrusions between which voids are defined.

These voids make it possible to increase the cushioning effect while the sole is in contact with the ground.

However, in these shoes the forces generated during the support phase are dissipated only with the deformation of the sole, whereas it would be desirable to obtain a more uniform distribution of the loads, so as to make optimal use of the forces in play during walking.

The technical problem addressed by the present invention is that of providing a shoe sole that is structurally and functionally designed to overcome one or more of the limitations described above with reference to the cited prior art.

In the context of the above-mentioned problem, a main aim of the invention is to develop a sole capable of making optimal use of the various phases of walking, while allowing effective cushioning during the support phase.

Another aim is to provide a shoe sole in which the stresses deriving from contact with the ground are not concentrated exclusively in the heel area or in any other single area.

This problem is solved and these aims are achieved by the present invention by means of a shoe sole comprising a main structure that defines a tread surface intended to face the ground during use of the sole and opposing sides of the sole, said main structure comprising a top layer facing, in use, the sole of the foot, a bottom layer facing the ground, and a reinforcing member interposed between the top layer and the bottom layer, said reinforcing member being made of a material with greater rigidity than said bottom layer, wherein said reinforcing member comprises a front portion and a rear portion joined together by a bridging section, and wherein a forefoot through opening is defined on said front portion and a hindfoot through opening is defined on said rear portion, and wherein a midfoot through opening is defined between said bridging section and said bottom layer.

Preferred features of the invention are defined in the dependent claims.

The sole according to the present invention makes it possible to obtain an optimal distribution of the loads that occur during the foot supporting phase.

In addition, the load generated during the supporting of the foot on the ground is distributed in a gradual manner, thus improving walking comfort.

In addition, the sole according to the present invention has high characteristics of reactivity and, at the same time, of deformability and adaptability to the movement of the foot.

According to preferred aspects, the invention also makes it possible to make optimal use of the energy accumulated during the foot supporting phase, transforming it into a pushing action.

According to further aspects, the present invention also makes it possible to favour the helical movement of the foot that arises during the various phases of walking.

According to other aspects, the invention also makes it possible to contain the peaks of pressure on the foot and, at the same time, to provide adequate support for the metatarsal area and the lateral arch.

According to still further aspects, the present invention makes it possible to advantageously combine characteristics of reactivity and deformability.

According to other aspects, the invention makes it possible to distribute the pressure of walking over a greater area of the plantar arch, reducing the risk of various pathologies.

According to a further aspect, the present invention also relates to a shoe sole comprising a main structure that defines a tread surface intended to face the ground during use of the sole and opposing sides of the sole, said main structure comprising:
a forefoot portion in which is defined a forefoot through opening that extends between the opposing sides;
a midfoot portion in which is defined a midfoot through opening that extends between the opposing sides;
a hindfoot portion in which is defined a hindfoot through opening that extends between the opposing sides;
said forefoot, midfoot and hindfoot portions being contiguous with each other along the toe-to-heel direction and being made of an elastic material, wherein said forefoot through opening and said hindfoot through opening partially overlap said midfoot through opening.

The sole according to the present invention makes it possible to obtain an optimal distribution of the loads that occur during the foot supporting phase.

In addition, the load generated during the supporting of the foot on the ground is distributed in a gradual manner, thus improving walking comfort.

According to preferred aspects, the invention also makes it possible to make optimal use of the energy accumulated during the foot supporting phase, transforming it into a pushing action.

According to further aspects, the present invention also makes it possible to favour the helical movement of the foot that arises during the various phases of walking.

According to a further aspect, the present invention also relates to a method for producing a sole, comprising the steps of:
providing a main structure;
providing a reinforcing member;
placing the reinforcing member between the top layer and the bottom layer;
joining the reinforcing member to the top layer and the bottom layer.

According to this aspect, the sole according to the present invention can be produced in an automated manner without requiring any particular manual processing steps.

The features and advantages of the invention will become clearer from the following detailed description of two embodiments illustrated by way of non-limitative example with reference to the accompanying drawings, in which:

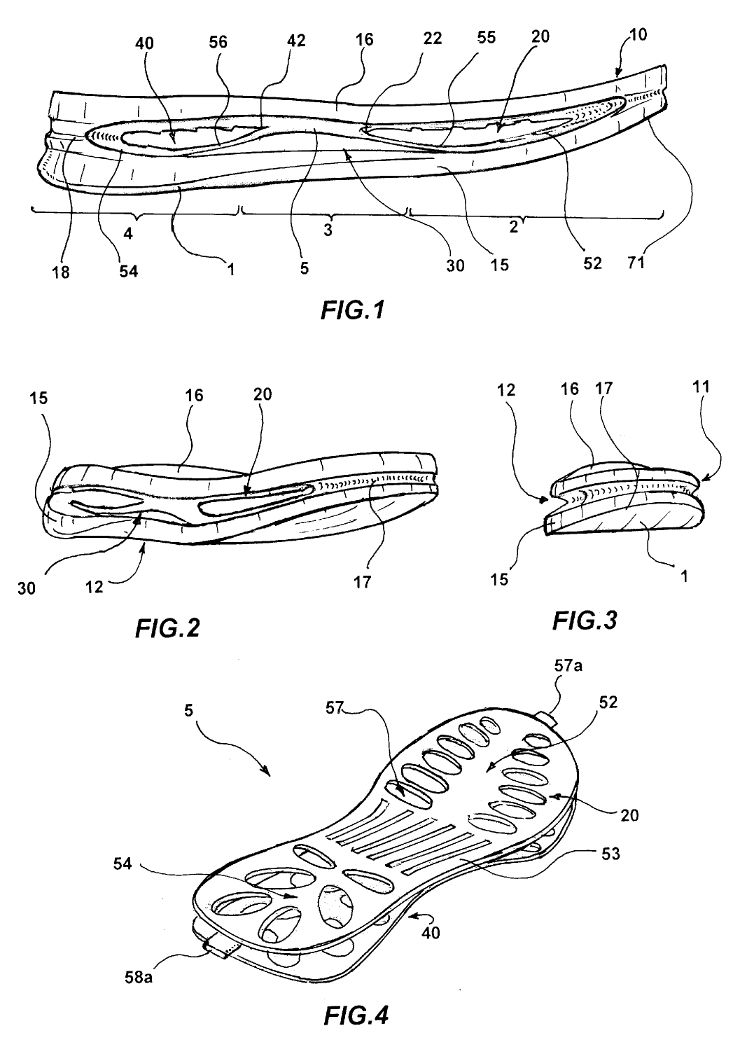

FIG. 1 is a side view of a shoe sole according to the present invention;

FIG. 2 is a perspective view of the shoe sole of FIG. 1;

FIG. 3 is a front view of the shoe sole of FIG. 1;

FIGS. 4 to 6 are respectively a perspective view, a side view and a plan view of a reinforcing member, a feature of the shoe sole according to the present invention;

FIG. 7 is a sectional perspective view of a variant embodiment of the shoe sole according to the present invention;

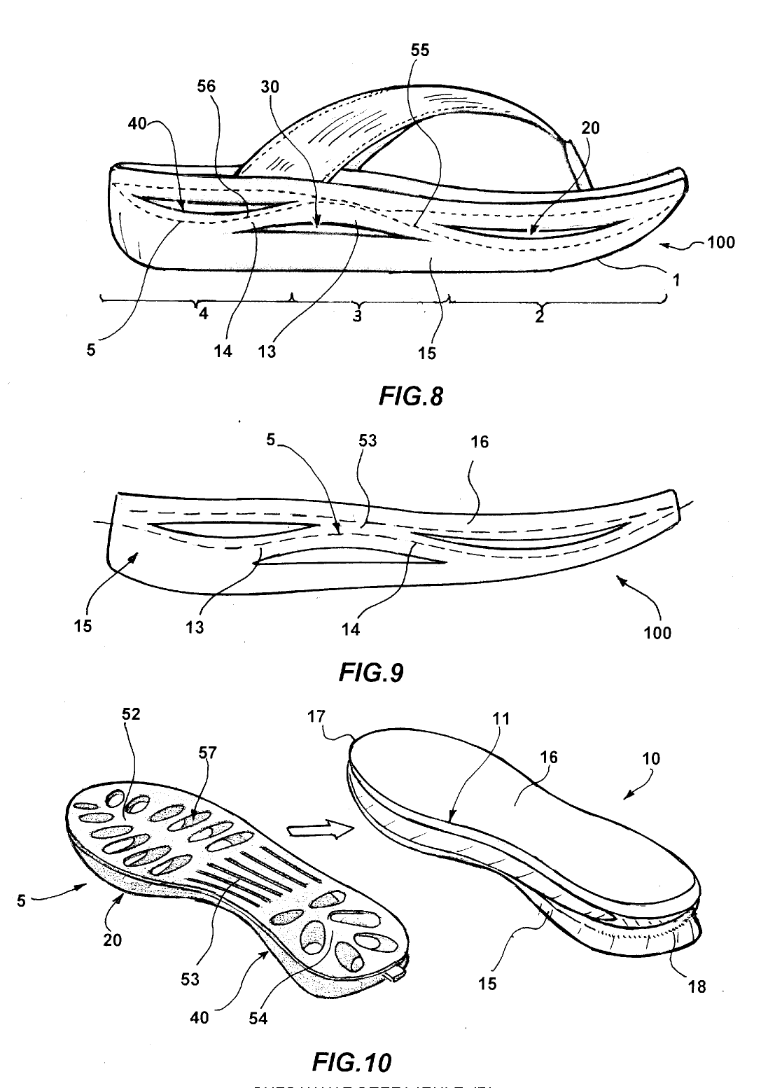

FIG. 8 is a side view of a shoe comprising the shoe sole according to the variant of FIG. 7;

FIG. 9 is a side view of a further variant embodiment of the shoe sole according to the present invention;

FIG. 10 is a perspective view that illustrates the method for producing the shoe sole according to the present invention;

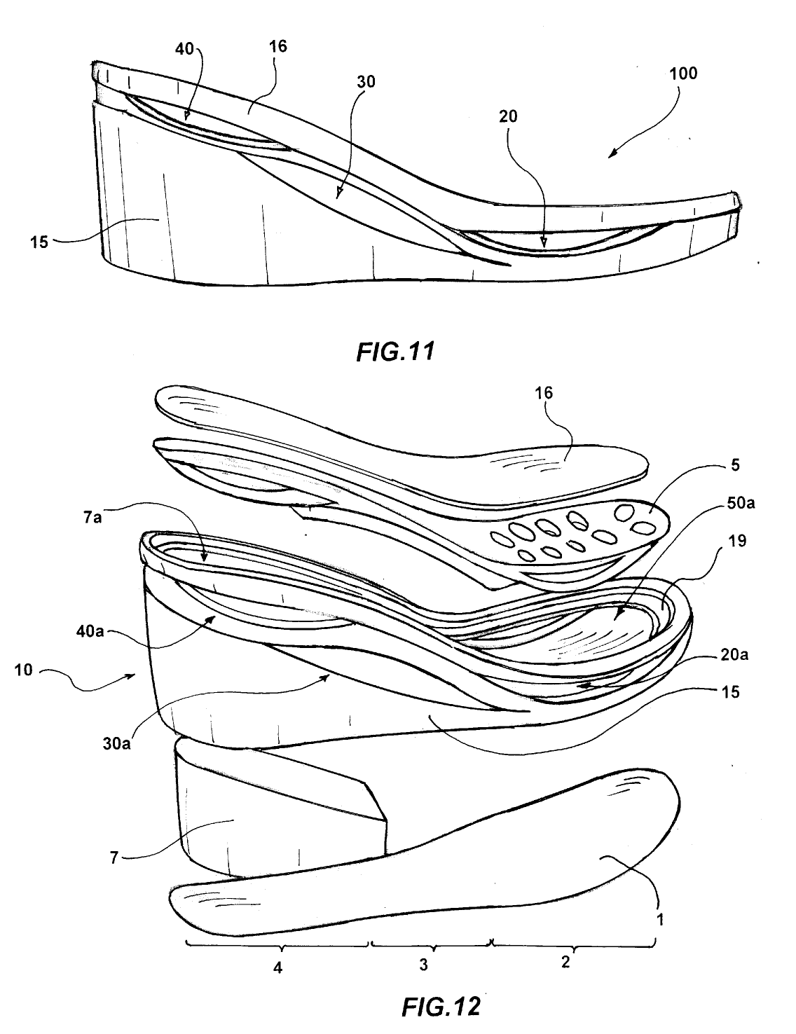

FIG. 11 is a side view of a still further variant embodiment of the shoe sole according to the present invention;

FIG. 12 is a perspective view that illustrates the method for producing the shoe sole according to the embodiment of FIG. 11;

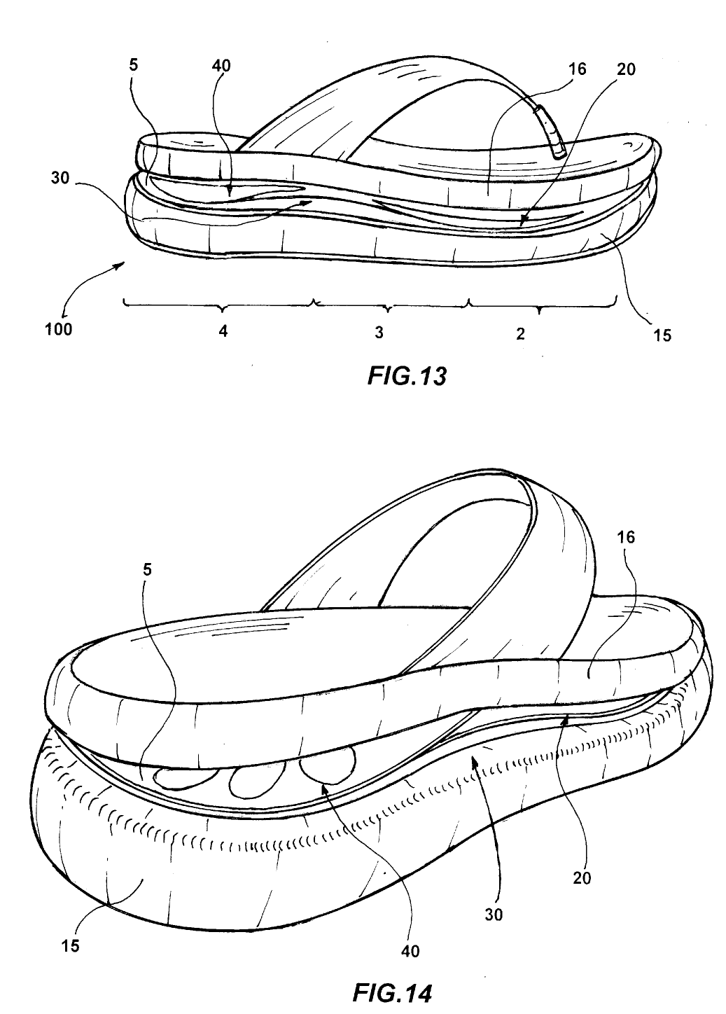

FIGS. 13 and 14 are respectively a side view and a perspective view of a shoe comprising the sole of the present invention according to a further embodiment;

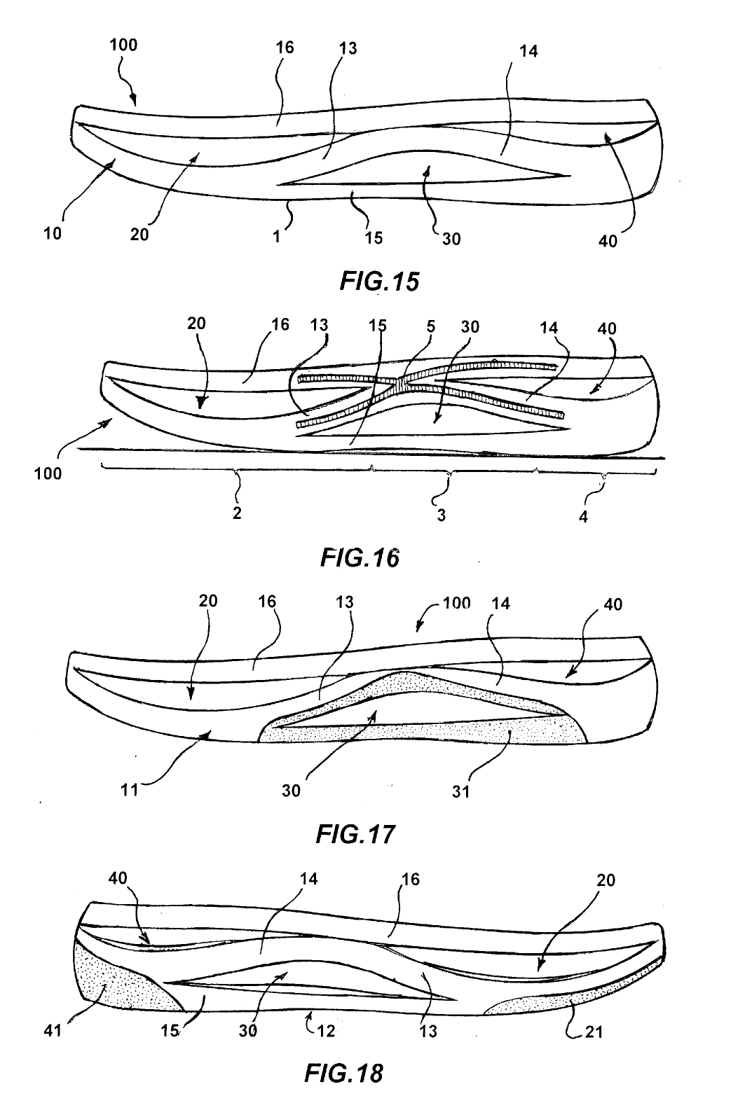

FIG. 15 is a side view of a variant embodiment of the shoe sole according to the present invention;

FIG. 16 is a partially sectional side view of a further variant embodiment of the shoe sole according to the present invention; and

FIGS. 17 and 18 are two side views, respectively relating to an outer side and an inner side, of a further embodiment of the shoe sole according to the present invention.

With reference initially to FIG. 1, the reference number 100 indicates overall a shoe sole produced in accordance with the present invention.

The sole 100 extends longitudinally in a toe-to-heel direction indicated with the letter X in FIG. 1.

The sole 100 comprises a main structure 10, which in turn includes a forefoot portion 2, a midfoot portion 3 and a hindfoot portion 4 contiguous with each other along the toe-to-heel direction X.

Preferably, the main structure 10 is made of a relatively elastic material, for example a polymer material, which will be illustrated in greater detail below.

Again with reference to FIG. 1, a tread surface 1 is identified in the main structure 10 of the sole 100.

In the context of the present invention, the term “tread surface 1” identifies the surface of the sole 100 intended to face the ground during use of the sole 100, i.e. during use of a shoe comprising the sole 100 by a user. This surface may be represented by that directly in contact with the ground, or said contact may take place via the interposition of additional layers not illustrated in the figure.

In the sole 100 are also identified respective opposing sides 11, 12, which comprise an inner side 11 and an outer side 12, identified in relation to the toe-to-heel direction X of the sole 100.

According to a preferred embodiment, the main structure 10 comprises a bottom layer 15 on which the tread surface 1 is defined.

Preferably, the main structure further comprises a top layer 16 facing, in use, the foot of the user.

According to a preferred embodiment, the top layer 16 and the bottom layer 15 are joined at a front end 17 of the sole 100, which defines the tip, and at a rear end 18, close to the heel.

In one embodiment, between the top layer 16 and the bottom layer 15 is provided a reinforcing member 5, preferably made of a material with greater rigidity than the main structure 10 or, more generally, at least than the bottom layer 15.

Preferably, the reinforcing member 5 is made of a material with a high degree of rigidity/elasticity, for example a block copolymer, such as ABS/nylon, or a polyether block amide, such as that known by the commercial name of Pebax®. A further alternative is represented by carbon or by a polyurethane, preferably of the compact thermoplastic type (TPU). However, it is clear that these materials are cited purely by way of example and that further alternatives can be also provided. In order to ensure that the reinforcing member has greater rigidity than the bottom layer 15 and/or the top layer 16, this or these are instead made of ethylene vinyl acetate (EVA) or expanded thermoplastic polyurethane (TPU).

According to a preferred embodiment, as illustrated more clearly in FIG. 4, the reinforcing member 5 comprises a front portion 52, arranged on the forefoot portion 2 of the sole 100, and a rear portion 54, arranged on the hindfoot portion 4. Preferably, the front portion 52 and the rear portion 54 are joined by a bridging section 53.

In a preferred embodiment, the reinforcing member 5 has an essentially flat development and extends to occupy the top layer 16 more or less completely. This makes it possible to prevent the user from noticing the presence of the reinforcing member 5 when wearing the shoe and, at the same time, can provide adequate support for the entire sole of the foot.

With reference to FIGS. 1 and 4, a through opening 20 is defined in the reinforcing member on its front portion 52. Hereinafter, said through opening will be referred to as the “forefoot through opening 20”, due to its location. According to a preferred embodiment, the forefoot through opening 20 extends between the opposing sides 11, 12 of the sole 100.

It should also be noted that the term “through” indicates that the opening not only passes entirely through the reinforcing member 5 but is open laterally on the opposing sides 11, 12 of the sole 100. Preferably, the forefoot through opening 20 passes through the shoe in a direction transverse to that defined as the toe-to-heel direction X.

In one embodiment, a through opening 40 is defined in the reinforcing member 5 on its rear portion 54. Hereinafter, said through opening will be referred to as the “hindfoot through opening 40”, due to its location.

According to a preferred embodiment, the hindfoot through opening 40 extends between the opposing sides 11, 12 of the sole 100. In other words, the hindfoot through opening 40 passes through the shoe in a direction transverse to that defined as the toe-to-heel direction X.

Preferably, a midfoot through opening 30 is defined between the bridging section 53 and said bottom layer 15 when the reinforcing member 5 is placed between the bottom layer 15 and the top layer 16.

As can be seen from FIG. 1, the bridging section 53 is preferably shaped in such a way that when the reinforcing member 5 is placed between the bottom layer 15 and the top layer 16, said top layer is raised relative to the bottom layer 15. In this way, the space consequently defined forms said midfoot through opening 30.

Preferably, the bridging section 53 is arranged to support the top layer 16, so as to provide complete support for the user's foot.

In this way, the reinforcing member 5 makes it possible to make optimal use of the forces in play during walking, absorbing energy, thanks to its flexion, in the support phase and subsequently releasing it during the extension of the foot.

Preferably, the reinforcing member 5 is formed as a single body.

According to a preferred embodiment, the front portion 52 and the rear portion 54 of the reinforcing member comprise a respective first transverse section 55 and a second transverse section 56, which connect to the bridging section 53.

Preferably, the first transverse section 55 is inclined towards the rear end of the sole 100, while the second transverse section 56 is inclined towards the front end of the sole 100.

Thanks to the above-mentioned arrangement, the transverse sections 55, 56 advantageously develop respectively along a direction parallel to that of the forces generated during the phase of support of the sole on the ground, and along a direction parallel to the forces released as a result of the elastic response in the phase of extension of the foot.

Preferably, the reinforcing member 5 is formed by two tubular elements, which define respectively the front portion 52 and the rear portion 54, connected by the bridging section 53. In one embodiment, the transverse sections 55 and 56 form a wall of the tubular elements.

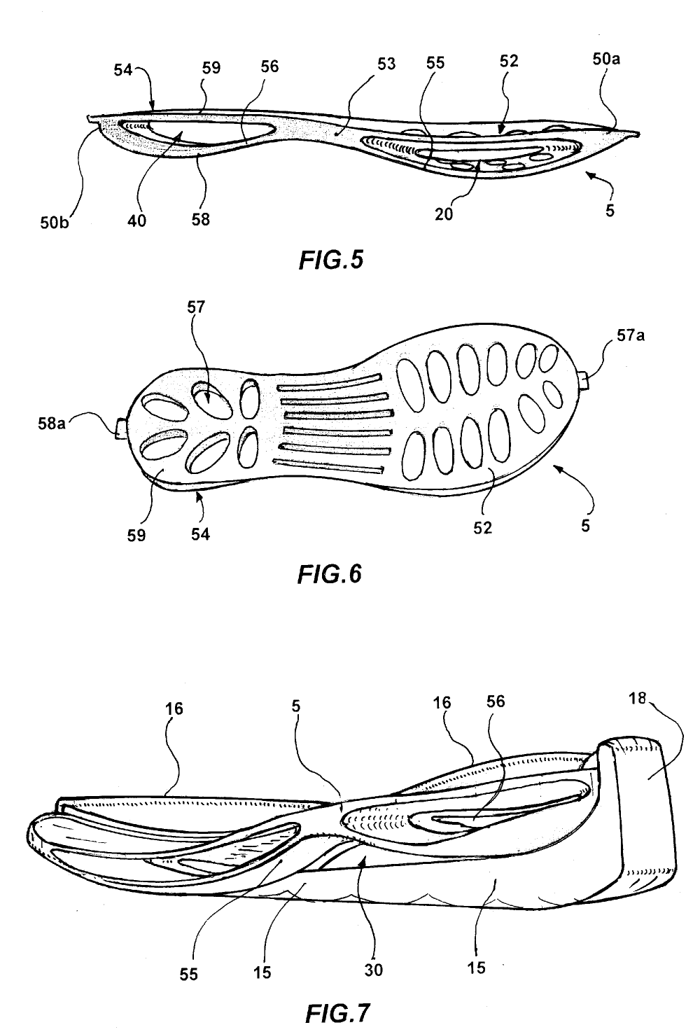

With reference to FIG. 5, in one embodiment, this structure is created by the superposition of two shaped sheets 58, 59, joined at a front area 50a, a rear area 50b and a central area that defines the bridging section 53, keeping the two sheets separate in the remaining areas.

As illustrated in FIG. 6, according to a preferred embodiment, the reinforcing member 5 also comprises lightening openings 57, preferably created on the shaped sheets 58, 59, which advantageously allow better adhesion between the reinforcing member 5 and the top and bottom layers 15, 16.

With reference once again to FIG. 1, the forefoot through opening 20, the midfoot through opening 30 and the hindfoot through opening 40 define voids between the top layer 16 and the bottom layer 15, respectively identified on the forefoot portion 2, the midfoot portion 3 and the hindfoot portion 4.

Preferably, in the sole according to the present invention, the forefoot through opening 20 and the hindfoot through opening 40 partially overlap the midfoot through opening 30.

In this way, the cushioning action obtained thanks to the presence of the openings can be advantageously combined with a high flexional capacity that is produced in the areas in which the openings overlap.

In one embodiment, the main structure 10 as a whole is affected by three through openings in total, defined by the forefoot through opening 20, the midfoot through opening 30 and the hindfoot through opening 40.

In this way, maximum flexibility of the sole can be obtained without sacrificing the cushioning effect during the phase of support and the release of forces during the extension of the foot.

In addition, a gradual distribution of the load is ensured.

Preferably, the forefoot through opening 20 and the hindfoot through opening 40 partially overlap the midfoot through opening 30 along a vertical direction defined when said tread surface is supported on the ground. In other words, one is arranged above the other in relation to the ground on which the sole 100 is supported.

According to a preferred embodiment, the forefoot through opening 20 overlaps the midfoot through opening 30 at an area of transition between the forefoot portion 2 and the midfoot portion 3. In parallel, the hindfoot through opening 40 overlaps the midfoot through opening 30 at an area of transition between the hindfoot portion 4 and the midfoot portion 3.

In this way, the areas of overlap advantageously correspond to those in which a greater degree of flexion is required during the movement of walking.

Preferably, with the aim of providing the structure with a high degree of strength, the forefoot through opening 20 and the hindfoot through opening 40 overlap the midfoot through opening 30 at respective tapered ends 22, 42.

According to an alternative embodiment, illustrated in FIGS. 7 and 8, said reinforcing member 5 is completely embedded in the structure 10.

In this embodiment, the top layer 16 and the bottom layer 15 are also connected by means of two transverse extensions 13, 14, within which are embedded the transverse sections 55, 56.

This advantageously makes it possible to conceal from view the presence of the reinforcing member 5, to the benefit of the aesthetic qualities of the sole 100.

In another embodiment, illustrated in FIG. 9, the reinforcing member 5 is made of compact thermoplastic polyurethane (TPU), while the bottom layer 15 is made of expanded thermoplastic polyurethane (TPU), so as to obtain a combination between materials with greater and lesser degrees of rigidity in a particularly simple constructional solution.

In a further variant embodiment, which defines a further aspect of the present invention, the reinforcing member 5 may not be present.

In this embodiment, the main structure 10 comprises a first transverse extension 13 that extends from the bottom layer 15, at an area facing the forefoot portion 2, to the top layer 16 at an area facing the midfoot portion 3. In other words, the first transverse extension 13 is inclined towards the rear end of the sole 100.

In a preferred embodiment, the main structure 10 also comprises a second transverse extension 14 that extends from the bottom layer 15, at an area facing the hindfoot portion 4, to the top layer 16 at an area facing the midfoot portion 3. In other words, the second transverse extension 14 is inclined towards the front end of the sole 100.

Preferably, the first and second transverse extensions 13, 14 are connected bridgewise to the top layer 16 at the midfoot portion 3.

Thanks to the above-mentioned arrangement, the transverse extensions 13, 14 advantageously develop respectively along a direction parallel to that of the forces generated during the phase of support of the sole on the ground, and along a direction parallel to the forces released as a result of the elastic response in the phase of extension of the foot.

In one embodiment, between the top layer 16, the bottom layer 15 and the first transverse extension 13 is defined a void, which identifies in the forefoot portion 2 a forefoot through opening 20 that extends between the opposing sides 11, 12.

Preferably, between the top layer 16, the bottom layer 15 and the two transverse extensions 13, 14 is defined a void, which identifies in the midfoot portion 3 a midfoot through opening 30 that extends between the opposing sides 11, 12.

Preferably, also between the top layer 16, the bottom layer 15 and the second transverse extension 14 is defined a void, which identifies in the hindfoot portion 4 a hindfoot through opening 40 that extends between the opposing sides 11, 12.

As illustrated for the other embodiments, the forefoot through opening 20 and the hindfoot through opening 40 preferably partially overlap the midfoot through opening 30.

With reference now to FIG. 10, the method for producing the sole according to the present invention is illustrated.

The reinforcing member 5 and the structure 10 are produced separately, preferably by injection moulding.

Preferably, the reinforcing member 5 and the structure 10 are subsequently washed with suitable cleaning products.

According to a preferred embodiment, an adhesive, preferably of the bi-component type, is applied to the reinforcing member 5 and the structure 10. Preferably, the surfaces of the reinforcing member 5 and the structure 10 intended to be joined together are coated with said bi-component adhesive.

The structure 10 is open on the sides, and consequently it is possible to insert the reinforcing member 5 laterally, from the inner side 11 or the outer side 12 of the sole.

Preferably, in order to favour the correct positioning of the reinforcing member 5, the latter may be provided with coupling elements 57a, 58a, suitable for creating a form fit with corresponding elements defined in the structure 10.

In one embodiment, said coupling elements are created by means of an extension insertable into a recess of complementary shape, created respectively on the reinforcing member 5 and the structure 10.

The unit formed by the structure 10 and the reinforcing member 5 is loaded into a cooling press, which is then closed, applying adequate pressure for the time necessary for the activation of the bi-component adhesive to take place.

In this phase, the presence of the lightening openings 57 allows adequate adhesion between the top and bottom layers and the reinforcing member.

FIG. 11 shows a further variant embodiment of the sole according to the present invention, intended to be used in a shoe of the “wedge” type.

In this case, the reinforcing member is embedded in the structure 10, as in the embodiments of FIGS. 7 and 8.

The method for producing said sole is described in FIG. 12 and is generally applicable to all embodiments in which the reinforcing member 5 is embedded in the structure.

The structure 10 is prepared by providing through openings 20a, 30a and 40a on the sides 11 and 12.

In addition, the structure 10 is provided with a central opening 50a, suitable for housing the reinforcing member 5.

In this case, the use of TPU/PU is additionally advantageous in that it makes it possible to produce the structure 10, already provided with the related openings, by injection moulding.

Preferably, the central opening 50a also defines a mating edge 19 on which the reinforcing member 5 can be placed in support.

In one embodiment, a further opening 7a with a vertical development is also provided in the hindfoot area 4, inside which is inserted a heel member 7.

The sole 100 is then assembled by placing the reinforcing member 5, and any heel member 7, in the corresponding openings 50a, 7a. Prior to their positioning, in a manner similar to the preceding embodiment, an adhesive, preferably of the bi-component type, is applied to the reinforcing member 5 and the structure 10.

According to a preferred embodiment, the top layer 16 is then placed on top of the reinforcing member 5. Preferably, the tread surface 1 is also applied beneath the bottom layer 15.

The assembly of the sole 100 is then completed by loading the unit thus obtained into a cooling press, which is then closed, applying adequate pressure for the time necessary for the activation of the bi-component adhesive to take place.

A further embodiment is illustrated in FIGS. 13 and 14.

According to this embodiment, the bottom layer 15 and the top layer 16 are separate and connected only by means of the reinforcing member 5 interposed between them.

In this case, the method for producing the sole 100 provides for the interposition of the reinforcing member 5 between the bottom layer 15 and the top layer 16 and the related gluing, using technologies similar to those illustrated previously.

In a still further variant embodiment, illustrated in FIG. 15, the through openings 20, 30, 40 are defined directly in the main structure, and therefore without requiring the presence of the reinforcing member 5.

In this embodiment, the top layer 16, the bottom layer 15 and the first transverse extension 13 define a void, which identifies in the forefoot portion 2 the forefoot through opening 20 that extends between the opposing sides 11, 12.

Preferably, between the top layer 16, the bottom layer 15 and the two transverse extensions 13, 14 is defined a void, which identifies in the midfoot portion 3 the midfoot through opening 30 that extends between the opposing sides 11, 12.

Preferably, also between the top layer 16, the bottom layer 15 and the second transverse extension 14 is defined a void, which identifies in the hindfoot portion 4 the hindfoot through opening 40 that extends between the opposing sides 11, 12.

According to a further embodiment, illustrated in FIG. 16, the reinforcing member 5 is essentially X-shaped, in such a way as to be capable of being formed as a single body and of being accommodated in the most convenient manner in the top layer 16 and in the two extensions 13, 14.

More generally, preferably the reinforcing member extends partially into the top layer 16 and into the transverse extensions 13, 14.

In this way, sufficient robustness and flexibility of the reinforcing member 5 can be ensured while occupying a very small portion of the main structure 10.

Preferably, the reinforcing member 5 is completely embedded in the top layer 16 and in the transverse extensions 13, 14.

This advantageously makes it possible to conceal from view the presence of the reinforcing member 5, to the benefit of the aesthetic qualities of the sole 100.

According to a further embodiment, illustrated in FIGS. 17 and 18, the sole 100 comprises, on the forefoot portion 2 and the hindfoot portion 4, respective portions with relatively greater flexibility 21, 41 at the outer side 12.

Preferably, the midfoot portion 3 comprises a further portion with relatively greater flexibility 31 at the inner side 11.

In this way, it is possible to favour the helical movement of the foot during the phases of walking, without compromising the overall characteristics of robustness and aesthetic quality of the sole.

In one embodiment, the portions with relatively greater flexibility 21, 31, 41 are made of a material with a lower density than the rest of the main structure 10.

Preferably, as can be seen from FIG. 17, the further portion with relatively greater flexibility 31 on the midfoot portion 3 extends into the bottom layer 15 and into the extensions 13 and 14.

As illustrated in FIG. 18, according to one embodiment, the portions with relatively greater flexibility 21, 41 extend at the level of the bottom layer 15.

It is evident that this embodiment can be advantageously combined with the presence of the reinforcing member 5.

Thanks to the characteristics of the invention, the shoe sole 100 makes it possible to make optimal use of the forces in play during the phases of walking.

In particular, the forefoot opening makes it possible to advantageously define a pushing control surface, while the midfoot opening makes it possible to define a dynamic stability area and the hindfoot opening makes it possible to define a control surface for the phases of compression, support and loading.

In addition, the presence of the reinforcing member is particularly advantageous in that it makes it possible to transport the force accumulated during the heel supporting phase into the front area, converting it into a pushing action.

The invention also makes it possible to contain the peaks of pressure on the foot and, at the same time, to provide adequate support for the metatarsal area and the lateral arch, thanks to the presence of the reinforcing member, which makes it possible to increase the support, combined with the presence of the holes that offset said effect of the reinforcing member.

In addition, the reactivity supplied by the reinforcing member is advantageously combined with the deformability of the structure.

This combination of characteristics also makes it possible to distribute the pressure over a larger area of the plantar arch, favouring a reduction in the risk of metatarsalgia, plantar fasciitis and other pathologies.

1. Shoe sole (100) comprising a main structure (10) that defines a tread surface (1) intended to face the ground during use of the sole (100) and opposing sides (11, 12) of the sole (100), said main structure (10) comprising a top layer (16) facing, in use, the sole of the foot, a bottom layer (15) facing the ground, and a reinforcing member (5) interposed between said top layer (16) and said bottom layer (15), said reinforcing member (5) being made of a material with greater rigidity than said bottom layer (15), wherein said reinforcing member (5) comprises a front portion (52) and a rear portion (54) joined together by a bridging section (53), wherein a forefoot through opening (20) is defined on said front portion (52) and a hindfoot through opening (40) is defined on said rear portion (54), and a midfoot through opening (30) is defined between said bridging section (53) and said bottom layer (15).

2. The shoe sole (100) according to claim 1, wherein:
said forefoot through opening (20) is defined in said forefoot portion (2) and extends between said opposing sides (11, 12);
said midfoot through opening (30) is defined in said midfoot portion (3) and extends between said opposing sides (11, 12);
said hindfoot through opening (40) is defined in said hindfoot portion (4) and extends between said opposing sides (11, 12);
said forefoot portion (2), midfoot portion (3) and hindfoot portion (4) being contiguous with each other along said toe-to-heel direction (X), said forefoot through opening (20) and said hindfoot through opening (40) partially overlapping said midfoot through opening (30).

3. The shoe sole (100) according to claim 1, wherein said reinforcing member (5) is formed as a single body.

4. The shoe sole (100) according to claim 1, wherein said reinforcing member (5) is completely embedded in said main structure (10).

5. The shoe sole (100) according to claim 4, wherein said top layer (16) and said bottom layer (15) are connected by at least two transverse extensions (13, 14), said transverse sections (55, 56) being embedded in said transverse extensions (13, 14).

6. The shoe sole (100) according to claim 1, wherein said reinforcing member (5) has an essentially flat development and extends to occupy the top layer (16) substantially completely.

7. The shoe sole (100) according to claim 1, wherein said forefoot through opening (20) and said hindfoot through opening (40) partially overlap said midfoot through opening (30) along a vertical direction defined when said tread surface is supported on the ground.

8. The shoe sole (100) according to claim 1, wherein said main structure (10) as a whole is affected by three through openings in total, defined by said forefoot through opening (20), said midfoot through opening (30) and said hindfoot through opening (40).

9. A method for producing the sole (100) of claim 1, the method comprising the steps of:
providing said main structure (10);
providing said reinforcing member (5);
placing said reinforcing member (5) between said top layer (16) and said bottom layer (15); and
joining said reinforcing member (5) to said top layer (16) and said bottom layer (15).

10. The method according to claim 9, wherein placing said reinforcing member (5) between said top layer (16) and said bottom layer (15) comprises the steps of:
inserting through one of said sides (11, 12) said reinforcing member (5) in such a way as to position it between said top layer (16) and said bottom layer (15).

11. The method according to claim 10, wherein joining said reinforcing member (5) to said top layer (16) and said bottom layer (15) comprises the steps of:
applying an adhesive prior to the insertion of said reinforcing member (5) between said top layer (16) and said bottom layer (15);
placing said main structure (10) with said reinforcing member (5) inserted between said top layer (16) and said bottom layer (15) in a cooling press.

12. A shoe sole (100) comprising a main structure (10) that defines a tread surface (1) intended to face the ground during use of said sole (100) and opposing sides (11, 12) of said sole (100), said main structure comprising:
a forefoot portion (2) in which is defined a forefoot through opening (20) that extends between said opposing sides (11, 12);
a midfoot portion (3) in which is defined a midfoot through opening (30) that extends between said opposing sides (11, 12);
a hindfoot portion (4) in which is defined a hindfoot through opening (40) that extends between said opposing sides (11, 12);
said forefoot portion (2), midfoot portion (3) and hindfoot portion (4) being contiguous with each other along said toe-to-heel direction (X) and being made of an elastic material, said forefoot through opening (20) and said hindfoot through opening (40) partially overlap said midfoot through opening (30).

13. The shoe sole (100) according to claim 12, wherein said main structure comprises a reinforcing member (5) made of a material with greater rigidity than said main structure (10), which extends between a zone of intersection of said forefoot through opening (20) with said midfoot through opening (30) and a zone of intersection of said midfoot through opening (30) with said hindfoot through opening (40).

14. The shoe sole (100) according to claim 13, wherein said main structure (10) comprises a bottom layer (15) on which is defined said tread surface (1), a top layer (15) facing, in use, the foot of the user, and at least two transverse extensions (13, 14) that develop between said bottom layer (15) and said top layer (16) in such a way as to define said forefoot through opening (20), said midfoot through opening (30) and said hindfoot through opening (40), said reinforcing member (5) being formed as a single body that extends partially into said top layer (16) and into said transverse extensions (13, 14).

15. The shoe sole (100) according to claim 14, wherein said reinforcing member (5) is completely embedded in said top layer (16) and in said transverse extensions (13, 14).

16. The shoe sole (100) according to claim 13, wherein said reinforcing member (5) extends to occupy said top layer (16) substantially completely.

17. The shoe sole (100) according to claim 12, wherein said forefoot through opening (20) and said hindfoot through opening (40) partially overlap said midfoot through opening (30) along a vertical direction defined when said tread surface is supported on the ground.

18. The shoe sole (100) according to claim 12, wherein said opposing sides (11, 12) comprise an inner side (11) and an outer side (12), said forefoot portion (2) and said hindfoot portion (4) comprise respective portions with relatively greater flexibility (21, 41) at said outer side, (12) and said midfoot portion (3) comprises a further portion with relatively greater flexibility (31) at said inner side (11).

19. The shoe sole (100) according to claim 12, wherein said main structure (10) as a whole is affected by three through openings in total, defined by said forefoot through opening (20), said midfoot through opening (30) and said hindfoot through opening (40).

20. The shoe sole (100) according to claim 12, wherein said forefoot through opening (20) and said hindfoot through opening (40) partially overlap said midfoot through opening (30) at respective tapered ends (22, 42) defined along said toe-to-heel direction (X).

21. The shoe sole (100) according to claim 12, wherein said forefoot through opening (20) overlaps said midfoot through opening (30) at an area of transition between said forefoot portion (2) and said midfoot portion (3), said hindfoot through opening (40) overlapping said midfoot through opening (30) at an area of transition between said hindfoot through opening (4) and said midfoot through opening (3).
